(19) United States
(12) Patent Application Publication
(10) Pub. No.: US 2010/0026457 A1
(43) Pub. Date: Feb. 4, 2010

(54) Location of Tagged Boxes

(75) Inventor: David Carr Holloway, Baldwinsville, NY (US)

Correspondence Address: KING & SPALDING, LLP, 1100 LOUISIANA ST., STE. 4000, ATTN.: IP Docketing, HOUSTON, TX, 77002-5213, US

(73) Assignee: Cooper Technologies Company, Houston, TX (US)

(21) Appl. No.: 12/185,487

(22) Filed: Aug. 4, 2008

(51) Int. Cl. H04Q 5/22

(52) U.S. Cl. 340/10.1

(57) ABSTRACT

Devices and methods described herein can allow an installer to locate an electrical box preinstalled behind building material. This approach can minimize the number of cuts in the building material, which can save time and can prevent the unnecessary loss of or damage to material. In some embodiments, the devices and methods can identify a particular circuit or type of outlet box, switchbox, ceiling box, ceiling fan box, junction box, or other type of box. In one example, a radio frequency identification (RFID) tag is secured to the box, wherein the RFID tag comprises an RFID antenna. An RFID reader is configured to broadcast to and receive transmissions from the RFID tag, wherein the reader comprises a reader antenna configured to broadcast to and receive transmissions from the RFID antenna. The reader indicates the presence and location of an RFID tag secured to the box when the box is pre-installed behind a building material.

### TECHNICAL FIELD

The present application relates generally to wirelessly locating a box, enclosure, or receptacle. More particularly, the present application relates to systems and methods utilizing an RFID tag to locate a box, enclosure, or receptacle behind an obstruction.

### BACKGROUND

Constructing a wall may require installing an electrical box (for example, an outlet box, switch box, junction box, or other such electrical box or enclosure) (referred to herein as a “box”) to one or more framing studs. An installer can then hang sheetrock, wall boards, or other building material from the studs (referred to herein as “building material”). As a result, the building material obscures the location of the box within the wall. To expose the preinstalled box, the building material must be appropriately cut at the proper location. Once the installer approximates a location of the box, the installer can drill a pilot hole. If the estimated location is indeed a precise location, the installer can trim the hole with a router or other cutting tool to an appropriate dimension and pattern of the box. An inexact determination of the location can result in extra cutting, which must later be repaired, often by different personnel. Additionally, in some instances, the building material must be discarded entirely.

The location can be approximated by various conventional methods. In one conventional method, an installer can measure the location of the box in relation to surrounding studs, the floor, and/or the ceiling. Once the building material is hung, the installer, knowing the approximate locations of those reference points, can use those measurements to attempt to locate the box. This conventional method, however, is time consuming and is not very accurate.

In another conventional method, an installer can mark a corresponding location of the box on the building material before hanging the building material. The installer can then cut a hole in the building material before installation. Because the building material is already cut, this approach attempts to eliminate any additional cutting to locate the box after hanging the building material. This conventional method, however, may be difficult for the installer to properly align the building material for marking. As a result, the installer may need to perform further cutting to adjust the dimensions of the hole, or the installer may cut the hole in the wrong location. This measure and marking approach can also be time consuming.

In yet another conventional method, an installer can position a first magnet in the box. Once the building material is hung, the installer can use a second magnet to locate the position of the first magnet. This conventional method, however, may not have a desired precision and is time consuming.

Therefore, a need exists for a tool that can precisely locate a box within a wall and can minimize the number of cuts in the building material to expose the box.

### SUMMARY

Devices and methods described herein can allow an installer to locate a box (for example, an outlet, switchbox, junction box, or other such electrical box or enclosure) preinstalled behind sheetrock, wallboard, or other building material. The exemplary embodiments of the devices and methods described herein can minimize the number of cuts in the building material to expose the box, which can save time and can prevent the unnecessary loss of material. According to some exemplary aspects, the devices and methods can identify a particular circuit or type of outlet box, switchbox, ceiling box, ceiling fan box, or other type of box.

In one aspect, a system for locating a pre-installed box behind a building material comprises a radio frequency identification (RFID) tag secured to the box. The RFID tag comprises an RFID antenna The system also comprises a reader configured to broadcast to and receive transmissions from the RFID tag, wherein the reader comprises a reader antenna configured to broadcast to and receive transmissions from the RFID antenna. The reader indicates the presence and location of an RFID tag secured to the box when the box is pre-installed behind a building material.

In another aspect, a method for locating a box comprising an RFID tag, wherein the box is configured to be installed in a wall or ceiling and obscured by a building material installed over the box on the wall or ceiling, comprises the steps of receiving a transmission from the RFID tag secured to the box and displaying indicia representative of a distance to the box. The indicia indicate the location on the building material for cutting the building material to expose the box.

These and other aspects, objects, and features of the invention will become apparent to those having ordinary skill in the art upon consideration of the following detailed description of exemplary embodiments exemplifying the best mode for carrying out the invention as presently perceived.

### BRIEF DESCRIPTION OF THE DRAWINGS

FIGS. 1a to 1c are perspective views of a box comprising an RFID tag according to an exemplary embodiment.

FIG. 2 is a schematic view of an RFID tag and a reader according to an exemplary embodiment.

FIG. 3 is a perspective view of a reader for locating an RFID tag according to an exemplary embodiment.

FIG. 4 is a side view of a cutting tool comprising an RFID tag reader according to an exemplary embodiment.

FIG. 5 is a flow chart depicting a method of locating of a box according to an exemplary embodiment.

### DETAILED DESCRIPTION

The present invention may be better understood by reading the following description of non-limitative embodiments with reference to the attached drawings wherein like parts of each of the figures are identified by the same reference characters.

Although the entity described herein for installing a box, hanging building material, locating the box, and cutting the building material is referred to as an installer, the installer is not intended to be limited to one person and may comprise a plurality of people to complete any one of or different tasks related to installing and locating the box. Additionally, the installer is not intended to be limited to an entity that physically installs an object, but instead may comprise any entity involved in the process described herein.

Sheetrock, also known as drywall, gypsum board, wallboard, and plasterboard, is typically comprised of a paper liner wrapped around an inner core made primarily from gypsum plaster, the semi-hydrous form of calcium sulfate. However, the use of the term sheetrock herein is not intended to be limited only to the materials commonly associated as sheetrock. Sheetrock is used as an exemplary material in the exemplary embodiments, but can be any building material, including, but not limited to, insulated panels, plywood, and cement boards and the like.

An enclosure, receptacle, housing, or box can be made of metal (for example, steel), plastic (for example, PVC), or other suitable material and can provide the structure for an electrical (for example, light) switch, outlet, junction, or other connection or use. For example, a box can be an outlet box, a switchbox, a ceiling box, a ceiling fan box, a junction box, or other enclosure known to one of ordinary skill in the art. Although the exemplary embodiments describe a box, the box is not intended to be limited only to a box for housing one light switch, outlet, or other connection. Instead, the switchbox may house a plurality (in other words, a gang) of electrical devices. The box can be any type, include any number of outlets, switches, or other devices, or provide any other use known to one of ordinary skill in the art. The box can also be any shape, including but not limited to a rectangle, square, hexagon, circle, or octagon.

A radio frequency identification (RFID) tag or transponder can transmit information to a reader. The RFID tag can store identification information, such as a serial number, and can transmit that identification information to an RFID reader. Any type of RFID tag can be used. The RFID tag can be an attachable tag, an insertion tag, or a tag either permanently or temporarily fixed to the box. For example, the tag can be affixed to the box using an adhesive. The RFID tag can also be reusable or disposable. The RFID tag can also comprise a rigid or flexible structure. The RFID tag can be tuned to one of many different frequencies, including, but not limited to, low-frequency (about 125 KHz), high-frequency (about 13.56 MHz), ultra-high-frequency or UHF (about 860 to 960 MHz), and microwave (about 2.45 GHz). The use of a particular frequency can depend on the desired range for locating the RFID tag from the reader, the antenna configuration, and the material that the frequency must penetrate between the box and the reader. The RFID tag can be inductively coupled, capacitively coupled, extended capability, passive, semi-passive, active, or any other configuration of RFID tags known to one of ordinary skill in the art.

According to one exemplary embodiment, the RFID tag can be passive. The passive RFID tag utilizes a reader for a power source, thereby requiring no internal power source. A small electrical current induced in the antenna by the incoming radio frequency signal can provide substantially enough power for the RFID tag to transmit a response to the reader. The passive RFID tag can transmit identification or other types of information, but can also comprise a non-volatile memory for storing data.

The RFID tag can also be semi-passive or active. Semi-passive and active RFID tags can have a power source, such as a small battery. In an active RFID tag, the power source can be used to power an integrated circuit and broadcast a signal to the reader. In a semi-passive RFID tag, the power source can power the microchip, but does not broadcast a signal. The semi-passive RFID tag only broadcasts a signal when interrogated by a reader. The power source can provide power to the RFID tag for transmitting information to the reader. Optionally, the battery or other power source can be removable. In an exemplary use of a semi-passive or active RFID tag, the battery can be removed once the box has been exposed through the building material. The battery can then be used in another RFID tag.

An RFID tag can be secured to a box in a permanent, semi-permanent, or temporary manner. It is intended that any suitable method for securing the RFID tag to a box can be used as long as the RFID tag remains functional. In exemplary embodiments, an RFID tag can be secured to a box using an adhesive, magnetism, or a screw or other fastener. In an alternative embodiment, an RFID tag can be positioned in a slot on a box designed to receive an RFID tag. In another alternative embodiment, the RFID tag can be removable for reuse. For example, once an installer locates a box and cuts a hole to expose the box through the building material, the installer can remove the RFID tag and secure the tag to another box.

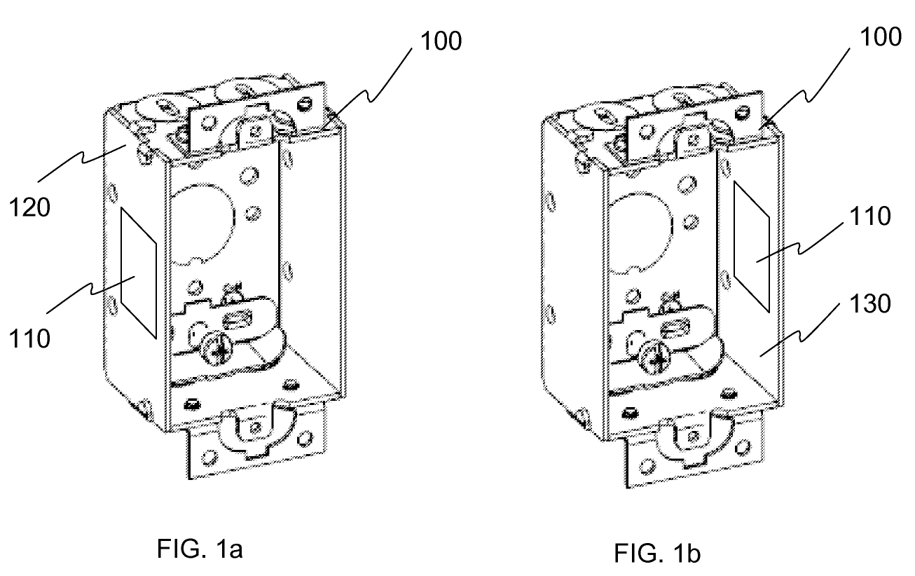

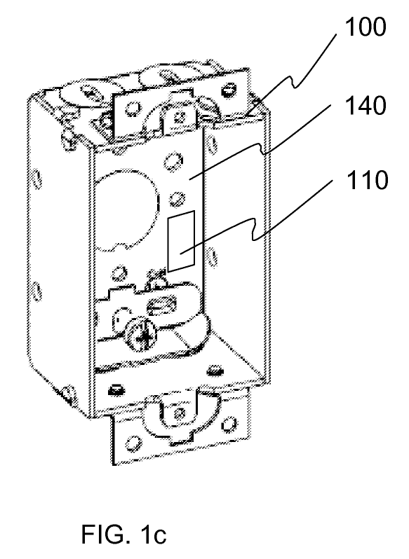

Referring to FIGS. 1a to 1c, an exemplary box 100 comprises an RFID tag 110 on an outer surface of a side wall 120 of the box 100 (as shown in FIG. 1a), on an inner surface of a side wall 130 of the box 100 (as shown in FIG. 1b), or on a back wall 140 of the box 100 (as shown in FIG. 1c). The location of the RFID tag 110 in the box 100 can depend on the installation of the box 100 in a wall or ceiling, the configuration of the box 100, or the desired location for drilling a pilot hole or first cut in the building material.

The location of the RFID tag 110 in the box 100 can assist an installer to identify the geometry of the box 100. For example, if the RFID tag 110 is located in the center of the box 100, an installer can identify the center of the box 100. In another example, if the RFID tag is located in a particular corner of the box 100 (for example, the lower left corner of the box 100) and it is customary to locate the RFID tag 110 in that particular corner, then the installer will know that the RFID tag 110 is in that corner when it is identified.

Multiple RFID tags can be used to identify a box and its configuration. For example, a first RFID tag can be located in a lower left corner and a second RFID tag can be located in an upper right corner of the box. By identifying each corner, the outline of the rectangular-shaped box can be identified. Any number of RFID tags, including one RFID tag or more than one RFID tag, can be used in a single box.

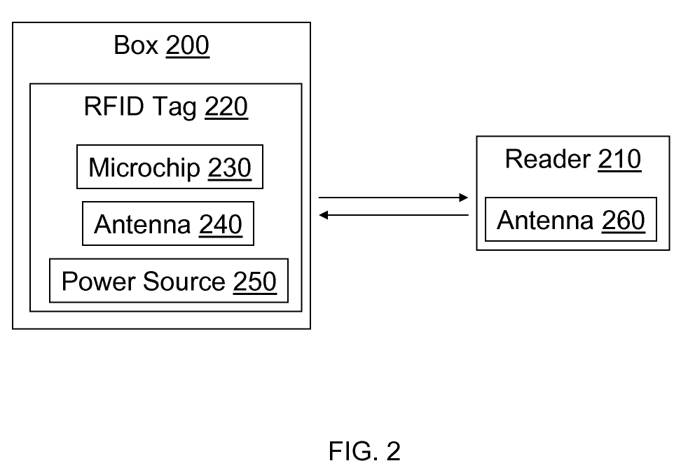

Referring to FIG. 2, a reader 210 can be used to locate a box 200 that comprises an RFID tag 220. The RFID tag 220 comprises a microchip 230, an antenna 240, and in some configurations, may also comprise a power source 250. The microchip 230 can store data and can wait to be read by reader 210. The antenna 240 can be tuned to receive electromagnetic energy (or electromagnetic waves) from an antenna 260 in the reader 210. Using a power source 250, such as a battery, or by harvesting power from the electromagnetic field of the reader 210, the RFID tag 220 can transmit radio waves to the reader 210. The reader 210 can receive the radio waves and interpret the frequencies as data, such as digital data. Although an integrated circuit is not shown in the exemplary embodiment of FIG. 2, it is understood that RFID tags can comprise an integrated circuit for storing and processing information as well as modulating and demodulating a signal.

As one alternative exemplary embodiment, the box can be an antenna to communicate with the reader. In a first example, a point or area on the box can emit a signal. In another example, a metal box may act as an antenna and emit a signal indicative of the shape of the box. In yet another example, an edge of the box can be used as an antenna to emit a signal indicative of that edge of the box.

A reader can be any suitable type of reader known for locating RFID tags. For example, the reader can be an agile reader that can read RFID tags operating at different frequencies or using different methods of communication between the RFID tags and readers. In an alternative example, the reader can read only one type of RFID tag using one frequency and one protocol.

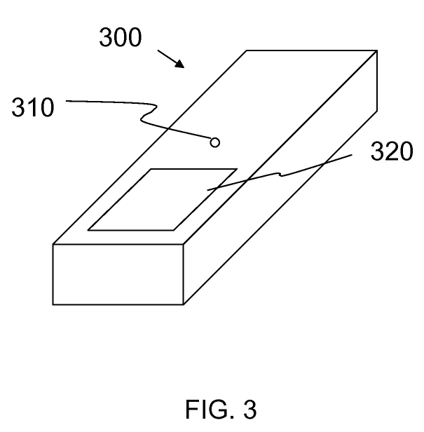

Referring to FIG. 3, a reader 300 is shown according to an exemplary embodiment. The reader 300 has an antenna (not shown) for broadcasting to and receiving transmissions from an RFID tag. The reader 300 can have a light emitting diode (LED) 310 or other indication mechanism, which can be illuminated when the reader is activated in an “on” position. The reader 300 can also have a display 320 that can display information received from the RFID tag or interpreted from information received from the RFID tag, such as a distance to the RFID tag, the strength of a signal from the RFID tag, or an identification of the type or shape of the box that is transmitting information to the reader 300. In the exemplary embodiment shown in FIG. 3, the display 300 can have a plurality of indicia lights, whereby more indicia lights are illuminated as the reader 300 approaches the RFID tag, based on, for example, the signal strength from the RFID tag or information received from the RFID tag. In an alternative exemplary embodiment, the reader 300 can indicate the type or shape of the box, such as an outlet or a two switch box, based on, for example, information received from the RFID tag. In another alternative exemplary embodiment, the reader 300 can indicate that the RFID tag is secured to a box associated with a particular circuit, based on, for example, information received from the RFID tag. The reader 300 can also indicate the optimal location for drilling a pilot hole, based on, for example, information received from the RFID tag or the signal received from the RFID tag.

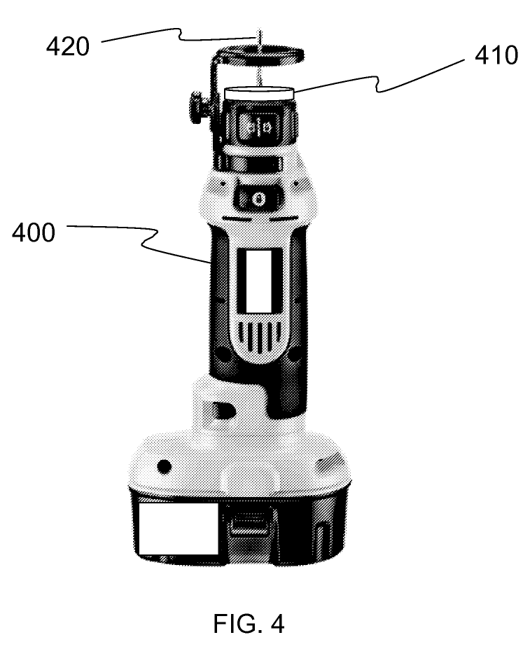

A reader can also be integrated into a tool that an installer uses to expose the box through the building material. Typically, the installer can use a drill, drywall cut-out tool, router, or other rotary tool. Referring to FIG. 4, a reader 410 can be integrated into a tool 400. In this exemplary embodiment, the reader is positioned near a drill bit 420, wherein such a position can allow the reader to be close to the building material without interfering in the drilling or cutting process. The reader 410 can comprise the same functionality described in the reader illustrated in FIG. 3. For example, reader 410 can display a distance to the RFID tag, the strength of a signal from the RFID tag, an identification of the type of box that is transmitting information to the reader 420, or identify an optimal location for drilling a pilot hole.

In an alternative exemplary embodiment, a reader can be used as an add-on or aftermarket component with a tool. The reader can be attached to the tool in a permanent, semi-permanent, or temporary manner. For example, the reader can be attached to the tool using a snap-on mechanism that can be released when not in use or for use on a different tool.

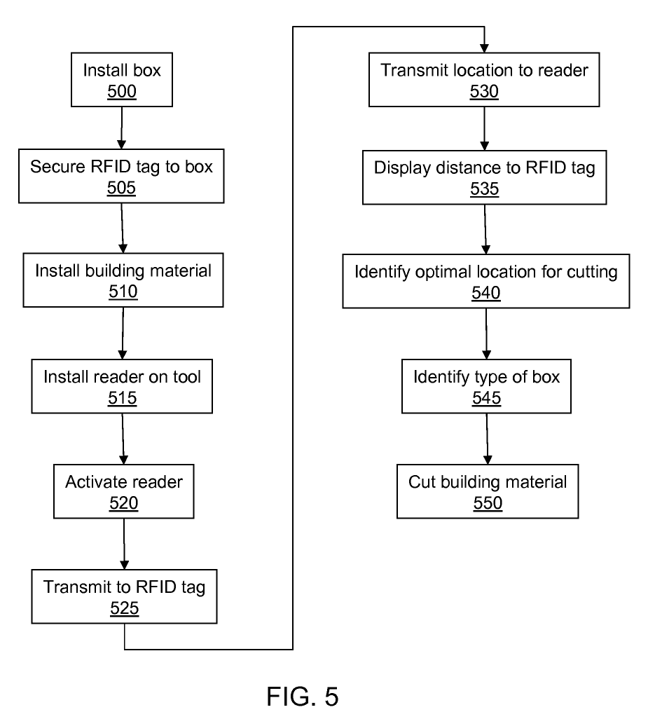

Referring to FIG. 5, an exemplary method is shown for identifying a location of a box pre-installed behind building material. In step 500, an installer can install a box, for example, to a wall stud or to a ceiling joist. In step 505, the installer can secure an RFID tag to the box, if the box does not already comprise an RFID tag.

In step 510, the installer can install building material, which will obscure the installed box. In step 515, the installer can install a reader on a tool, unless the tool has an integrated reader or if the reader is a separate device for use without a tool.

In step 520, the installer activates the reader. In step 525, the reader transmits a broadcast to the RFID tag secured to the box. In step 530, the RFID tag transmits its location and/or other information to the reader.

In step 535, the reader can display its distance to the RFID tag, including an arrow or other indicator pointing in the general direction toward the RFID tag. Alternatively, the reader can audibly indicate the proximity to the RFID tag or the type of RFID tag. For example, an audible indication can include a pulsing tone that pulses at a faster rate when the reader approaches the RFID tag. In step 540, the reader can identify an optimal location for cutting the building material, for example, where to drill a pilot hole, based on the information received from the RFID tag.

In step 545, the reader can identify a type of box, such as a switchbox, junction box, or outlet box, based on the information received from the RFID tag, so that the installer knows the dimensions of the box located behind the building material. For example, the information regarding the type of box can include the box dimensions. Alternatively, the installer can reference other information based on the box identification to determine the box dimensions. In step 550, the installer can cut the building material accordingly to expose the box. For example, having located the position of the box using the RFID tag information, the installer can insert the tool through the building material and can cut the building material using the box as a guide.

The exemplary method depicted in FIG. 5 can be altered as appropriate by, for example, performing the steps in a different order, omitting steps, and/or adding steps.

Therefore, the present invention is well adapted to attain the ends and advantages mentioned as well as those that are inherent therein. The particular embodiments disclosed above are illustrative only, as the present invention may be modified and practiced in different but equivalent manners apparent to those having ordinary skill in the art having the benefit of the teachings herein. While numerous changes may be made by those having ordinary skill in the art, such changes are encompassed within the spirit and scope of this invention as defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present invention as defined by the claims below. The terms in the claims have their plain, ordinary meaning unless otherwise explicitly and clearly defined by the patentee.

What is claimed is:

1. A system for locating a pre-installed box behind a building material, comprising:
at least one radio frequency identification (RFID) tag substantially adjacent to the box; and
a reader configured to broadcast to and receive transmissions from the RFID tag,
wherein the reader comprises a reader antenna configured to broadcast to and receive transmission from the RFID antenna;
wherein the reader indicates the presence and location of an RFID tag when the box is pre-installed behind a building material.

2. The system according to claim 1, wherein the RFID tag comprises a removable power source.

3. The system according to claim 2, wherein the reader is configured to be attached to a tool.

4. The system according to claim 3, wherein the reader is configured to be removably attached to the tool.

5. The system according to claim 1, wherein the reader comprises a display.

6. The system according to claim 5, wherein the display indicates the distance from the reader to the RFID tag secured to the box.

7. The system according to claim 5, wherein the display indicates a signal strength.

8. The system according to claim 5, wherein the display identifies a type of box.

9. The system according to claim 5, wherein the display identifies a shape of the box.

10. The system according to claim 1, wherein the RFID tag is passive, active, or semi-passive.

11. The system according to claim 1, wherein the box comprises a switchbox, outlet box, or junction box.

12. The system according to claim 1, wherein the RFID tag is temporarily secured to the box.

13. The system according to claim 1, wherein the RFID tag further comprises a microchip configured to store identification information.

14. The system according to claim 1, wherein the RFID tag is secured to a surface of the box.

15. The system according to claim 1, wherein the RFID rests on a surface of the box.

16. The system according to claim 1, wherein the RFID tag comprises an antenna.

17. The system according to claim 1, wherein the box comprises an antenna.

18. A method for locating a box comprising at least one RFID tag, wherein the box is configured to be installed in a wall or ceiling and obscured by a building material installed over the box on the wall or ceiling, the method comprising the steps of:
receiving a transmission from the RFID tag secured to the box; and
displaying indicia representative of a distance to the box based on the received transmission;
wherein the indicia indicates a location on the building material for cutting the building material to expose the box.

19. The method according to claim 18, further comprising the step of identifying a type of the box.

20. The method according to claim 18, further comprising the step of removing a power source from the RFID tag once the box is exposed.

21. The method according to claim 18, further comprising the step of activating a reader that transmits the broadcast to the RFID tag and receives a transmission from the RFID tag.

22. The method according to claim 21, further comprising the step of installing the reader on a tool.

23. The method according to claim 18, wherein the step of transmitting a broadcast further comprises transmitting identification information.

24. The method according to claim 18, wherein the box comprises a switchbox, outlet box, or junction box.

25. The method according to claim 18, wherein the RFID tag is temporarily secured to the box.

26. The method according to claim 18, wherein the RFID tag is passive, active, or semi-passive.

27. The method according to claim 18, further comprising the step of transmitting a broadcast to the RFID tag secured to the box.

28. A system for locating a pre-installed electrical box behind a building material, comprising:
an electrical box; and
a radio frequency identification (RFID) tag coupled to the box,

29. The system according to claim 28, further comprising an RFID reader configured to broadcast to and receive transmissions from the RFID tag to identify a location of the box behind the building material.

30. The system according to claim 28, wherein the electrical box comprises an antenna.
